(19) United States
(12) Patent Application Publication
(10) Pub. No.: US 2021/0136114 A1
(43) Pub. Date: May 6, 2021

(54) INSTANT POLICY ENFORCEMENT

(71) Applicant: MICROSOFT TECHNOLOGY LICENSING, LLC, Redmond, WA (US)

(72) Inventors: Violet Anna BARHUDARIAN, Kirkland, WA (US); Jiangfeng LU, Bothell, WA (US); Caleb Geoffrey BAKER, Seattle, WA (US); Oren Jordan MELZER, Redmond, WA (US); Anirban BASU, Sammamish, WA (US); Carlos Adrian LOPEZ CASTRO, Duvall, WA (US)

(21) Appl. No.: 16/670,864

(22) Filed: Oct. 31, 2019

(51) Int. Cl. H04L 29/06; H04L 9/32

(52) U.S. Cl. CPC H04L 63/20; H04L 63/105; H04L 9/3271; H04L 9/3213; H04L 63/0884

(57) ABSTRACT

Implementing policy at a resource provider computer system. The method includes a resource provider computer system receiving policy from an identity provider system, the policy being related to an entity that authenticates using the identity provider computer system. The resource provider computer system receives a request for resources from the entity and an access token from the entity. The access token was obtained by the entity from the identity provider computer system as a result of the entity authenticating with the identity provider computer system. The resource provider computer system evaluates the request with respect to the policy. The resource provider computer system responds to the request based on evaluating the request with respect to the policy.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing system's ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

For example, an entity may be configured to access resources from a resource provider where the resource provider is a remote computing system. To obtain access to these resources, the entity will typically authenticate with an identity provider to receive an access token and a refresh token, where the access token can be presented to the resource provider in a request for resources. If the access token is valid, an authenticated user session is created between the resource provider and the entity to provide the resources.

In particular, IT administrative policies for an organization are often configured centrally on an identity provider, which authenticates entities and provides credentials used by entities in the organization) used by the organization. The policies are then enforced by the identity provider when issuing authentication artifacts (e.g., access tokens) that are used to confirm a user's identity. Before issuing an access token to the user, the identity provider evaluates administrative policies to ensure the user's compliance. The access token is then passed, by the entity, to a resource provider that grants resource access based on the information in the access token. After the access token is issued and until it reaches its expiration, the identity provider has no means to update resource providers on changes in the user's security state. For example, if the user's employment has been terminated, the user will continue to have access to the resources until the user's access tokens expire.

For example, access tokens will often be issued by an identity provider where the access tokens are valid for one hour. Thus, there could be a one-hour time frame when an entity should not have access to resources at a resource provider when the entity could obtain access to the resources.

Further, access policy is dependent on factors that the identity provider can determine at the time the access token is issued to the entity. However, if the entity falls out of compliance during the refresh time period, the entity may still be able to access resources at the resource provider, against policy.

Alternatively, or additionally, there may be policies that are difficult for the identity provider to enforce. That is, the identity provider may not be able to gather sufficient information at token issuance time to determine whether or not the entity is in compliance with policies configured at the identity provider.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of implementing policy at a resource provider computer system. The method includes a resource provider computer system receiving policy from an identity provider system, the policy being related to an entity that authenticates using the identity provider computer system. The resource provider computer system receives a request for resources from the entity and an access token from the entity. The access token was obtained by the entity from the identity provider computer system as a result of the entity authenticating with the identity provider computer system. The resource provider computer system evaluates the request with respect to the policy. The resource provider computer system responds to the request based on evaluating the request with respect to the policy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system for providing enterprise policy to resource providers to allow resource providers to enforce the policy;

FIG. 2 illustrates a policy portal and an identity provider, and an administrator interacting with the policy portal to set policy for the enterprise;

FIG. 3 illustrates one embodiment of an identity provider providing policy to a resource provider;

FIG. 4 illustrates one embodiment of an identity provider providing policy to a resource provider;

FIG. 5 illustrates one embodiment of an identity provider providing policy to a resource provider;

FIG. 6 illustrates one embodiment of an identity provider providing policy to a resource provider;

FIG. 7 illustrates one embodiment of an identity provider providing policy to a resource provider;

FIG. 8 illustrates one embodiment of an identity provider providing policy to a resource provider;

FIGS. 9A-9D illustrates various ways of consent being given for policy to be provided on behalf of an entity;

FIG. 10 illustrates a method of implementing policy at a resource provider computer system;

FIG. 11 illustrates a method of implementing policy in a computer system; and

FIG. 12 illustrates a computing system where embodiments may be practiced.

### DETAILED DESCRIPTION

Embodiments illustrated herein are directed to practical applications of providing administrative policy from an identity provider to a resource provider allowing the resource provider to enforce policy when an entity contacts the resource provider to access resources administered by the resource provider.

In particular, a technical problem exists in that administrative policies are generally enforced by an identity provider computer system which provides access tokens to entities at authentication time such that the identity provider can enforce policy at that time, but loses the ability to enforce policy at subsequent times should the entity fall out of compliance with the policy or should the policy be a policy that is better administered by a resource provider administering resources to the entity. That is, a technical problem exists that administrative policy implemented by an organization may not be properly enforced due to the nature of relationships between an entity, an identity provider, and a resource provider. Typically it is not feasible to configure resource providers to enforce policy as doing so affects the scalability of enterprise systems. In particular, it is expensive in terms of computational resources and administrator resources to reconfigure resource providers any time there is a policy change or any time there is a change that would necessitate revoking a user session. As the number of resource providers increases in such systems, cost in terms of computational resources and administrator resources increases proportionally. Thus, a system that requires each resource provider computer system to be reconfigured would necessarily need to be limited in the number of resource provider computer systems that could be implemented. Further, requiring each resource provider to be reconfigured would require a system that was able to track and manage all resource providers in a fashion that allowed them to be reconfigured. Further, requiring each resource provider to be reconfigured could actually take more time than simply allowing a token to expire, thus negating any benefit achieved by reconfiguring the resource provider computer systems. Thus, there is a need for systems which allow for highly scalable numbers of resource providers to be added to the enterprise system while still being able to address the need to invalidate unexpired tokens. This can be particularly important in cloud-based systems where resource providers can be quickly added, except when external constraints such as those illustrated above are placed on the systems.

Embodiments illustrated herein are able to cause a technical effect whereby administrative policy can be enforced at the resource provider level when an entity requests resources from the resource provider. This technical effect can be achieved by the technical means of providing policies from an identity provider computing system to a resource provider computing system, which allows the resource provider computing system to enforce the policies when the entity requests resources from the resource provider computing system.

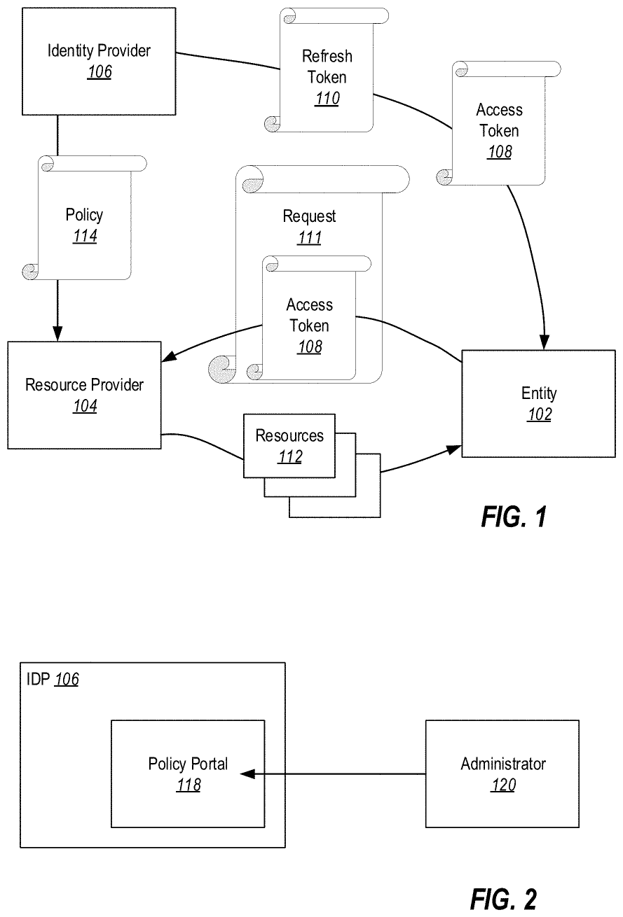

Referring now to FIG. 1, an example is illustrated. FIG. 1 illustrates an entity 102. In the illustrated example, the entity 102 may include a user, the device, and associated clients (e.g., applications) used by the user. Note that the user is not necessarily a human user. The entity 102 may have need to access resources from a resource provider 104. The resource provider 104 is a computer system configured to administer computing resources to users. The resources may be stored at the resource provider 104, or may be obtained by the resource provider from other sources.

To obtain access to the resources, the entity will first authenticate with an identity provider 106. The identity provider is a computing system configured to administer policy and to issue cryptographic tokens to entities to allow the entities to access resources from resource providers. The entity 102 can authenticate to the identity provider 106 through any one of a number of different well-known authentication and access token issuance schemes, other less well-known authentication schemes, or even future authentication schemes yet to be developed. Suffice it to say, in the particular example shown in FIG. 1, the entity 102 receives from the identity provider 106 an access token 108 and a refresh token 110.

The access token 108 typically includes a timestamp indicating when the access token was issued. The access token 108 may alternatively or additionally include information indicating when the access token 108 expires. In some embodiments, the access token 108 may include information about authentication procedures used by the entity 102 to authenticate to the identity provider 106. For example, the access token 108 may indicate that the access token 108 was obtained by the entity 102 authenticating to the identity provider using a simple identity and secret authentication procedure, such as when the identity is a username and the secret is a password. Alternatively or additionally, if the entity 102 authenticated to the identity provider 106 using double factor authentication, this can be indicated in the access token 108. Alternatively or additionally, if the entity 102 authenticated to the identity provider using a certain strength of password, this sort of information can be indicated in the access token 108 itself. For example, the access token may indicate the minimum length of password used to authenticate to the identity provider, use of special characters in the password used to authenticate to the identity provider, use of both upper and lowercase letters in the password used to authenticate to the identity provider, absence of common passwords or other words in the password used to authenticate to the identity provider, etc.

In some embodiments, the access token 108 will be for a particular user as well as for a client used by the particular user. Thus, in this example, the entity 102 includes both the user and the client used by the user. For example, the user may use a laptop computer with a corresponding laptop computer client to perform the authentication and resource requests. Thus, the access token 108 may include information about the laptop computer client of the entity 102. Alternatively, the user may use a smart phone to perform the authentication, in which case a corresponding smart phone client is used to perform the authentication and to perform resource requests, meaning that the access token 108 will be for an entity 102 including a user using a smart phone client.

Returning once again to the example illustrated in FIG. 1, the entity 102 can provide the access token 108 to the resource provider 104 in a request for resources from the resource provider 104. The resource provider 104 can evaluate the access token to determine that the entity 102 has been properly authenticated to the identity provider 106 and that the access token 108 is otherwise valid. In particular, the access token 108 may have an expiration and the resource provider 104 can determine that the access token 108 has not expired. Ordinarily, so long as this evaluation of the access token 108 passes the various checks, then the resources 112 will be provided to the entity 102. However, embodiments illustrated herein can implement additional checks with respect to the request 111 by the entity 102 to the resource provider 104.

In particular, FIG. 1 illustrates that the resource provider 104 can receive policy 114 from the identity provider 106. This allows the resource provider 104 to administer the policy 114 on behalf of the identity provider 106.

Referring now to FIG. 2, additional details are illustrated. FIG. 2 illustrates that the identity provider 106 includes a policy portal 118. The policy portal 118 includes various user interfaces that can be accessed by an administrator 120 to allow the administrator 120 to configure policy for distributing resources within a system. Referring once again to FIG. 1, if the policy is better administered by the resource provider 104, then the policy 114 can be provided to the resource provider 104 and administered by the resource provider 104 to control how resources 112 are provided to the entity 102 according to the policy 114. Referring once again to FIG. 2, in some embodiments, the administrator can identify policies by selecting certain options displayed in the policy portal 118 indicating that a policy should be administered by the resource provider 104. In some embodiments, the administrator 120 can identify certain conditions, time periods, etc. when the policy should be provided to the resource provider 104 in the policy portal 118.

Particular examples are now illustrated.

Some embodiments may have a location based policy that needs to be enforced. For example, an enterprise may have a need to implement a different level of protection when users attempt to access resources from inside of a trusted network as compared to an attempt to access resources from un-trusted network. For example, the trusted network is the normal corporate intranet used by the enterprise, and thus greater levels of security and lower levels of risk can be assumed. Thus, an enterprise may wish to allow access to certain resources when an entity attempts to access those resources from the corporate intranet. For the same resources, when an entity attempts to access the resources from outside of the corporate intranet, the entities may be blocked.

Alternatively, it may be desirable to obtain additional authentication to allow access the same resources outside of the corporate intranet. For example, some embodiments may require multi-factor authentication if an entity 102 attempts to access the resources 112 on a system that is outside of the corporate intranet. To accomplish this, the policy 114 is implemented at the resource provider. For example, the resource provider 104 can determine if the access token 108 was issued using multifactor authentication and if the entity 102 is attempting to access the resources 112 outside of the corporate intranet. If the entity 102 attempts to access the resources 112 from outside of the corporate intranet using an access token 108 issued using single factor authentication, then the resource provider 104 can invalidate the user session and cause the entity 102 to re-authenticate to the identity provider 106 to obtain an access token issued using multifactor authentication.

Note that by having the identity provider 106 provide the policy 114 to the resource provider 104, it should be appreciated that the identity provider 106 can provide the policy 114 to any resource provider to which the policy 114 is relevant. This creates a scalable system that is able to quickly and efficiently distribute policy to resource providers as needed. This eliminates the need to manually configure the various resource providers as well as the applications running on those resource providers or on the entities attempting to access resources from the resource providers. This allows the system to scale efficiently.

In particular, administrators simply need to configure the policy in an identity provider portal.

Additionally, if administrators attempt to configure certain policies, such as multifactor authentication, at the resource provider, they are unable to do so because the resource provider does not support certain functionality and understanding related to multifactor authentication itself or other types of authentication. Resource providers are limited to providing access or blocking access.

By configuring the policy with the identity provider, greater granularity can be achieved in policy enforcement. For example, different authentication methods may be able to be configured. Additionally, the use of the identity provider for receiving administrator input for configuring policy allows the administrator to globally administer policy in one central location.

Thus, embodiments herein are able to address this situation by allowing the resource provider to download policy from the identity provider. Stated differently, the identity provider can share administrator configured policy with the resource provider. At this point, the resource provider has the policy and can directly enforce the policy on the user when the user attempts to access resources at the resource provider.

For example, in some embodiments as described above, a resource provider can determine whether a user is attempting to access resources from a trusted location or from an un-trusted location. If the user is attempting to access the resources from an un-trusted location, the resource provider can directly apply policy related to un-trusted location attempts to access resources. For example, if a user attempts to access resources from an un-trusted location using an access token that was obtained in a fashion that is not compliant for un-trusted location access (e.g., the token was obtained using single factor authentication), then the resource provider can terminate the user session, thus invalidating the token and direct the user back to the identity provider to obtain appropriate credentials (e.g., using multi-factor authentication to obtain a token), for accessing resources from an un-trusted location according to policy configured by an administrator.

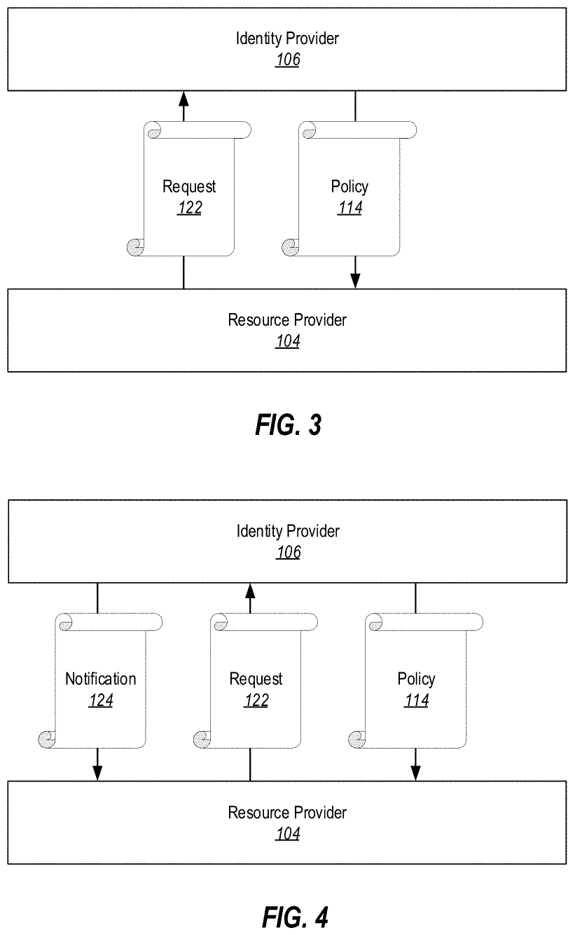

Referring now to FIG. 3, one embodiment is illustrated. In the example illustrated in FIG. 3, the resource provider 104 can send a request 122 for the policy 114 from the identity provider 106. In response, the identity provider 106 can provide the policy 114 to the resource provider 104, where the resource provider 104 can administer the policy when entities attempt to access resources from the resource provider.

Note that in some embodiments, the policy 114 may be limited in scope. For example, in some embodiments the policy 114 may apply to a particular entity or to a particular group of entities. Alternatively, or additionally, the policy 114 may apply globally to all entities attempting to access resources in a system. Alternatively, or additionally, in some embodiments, the policy 114 is applicable only to certain resource providers or classes of resource providers.

Referring now to FIG. 4, an alternative embodiment is illustrated. In FIG. 4, the identity provider 106 may be configured to notify the resource provider 104 any time that policy has been updated at the identity provider 106. For example, an administrator may update policy and the identity provider 106 through a policy portal. Once this occurs, the identity provider 106 may automatically send a notification 124 to the resource provider 104 notifying the resource provider that additional policy is available at the identity provider 106. In response, the resource provider 104 sends a request 122 to the identity provider 106 to obtain the policy 114. In response to the request 122, the identity provider 106 provides the policy 114 to the resource provider 104 where the resource provider can then administer the policy as entities attempt to access resources from the resource provider 104.

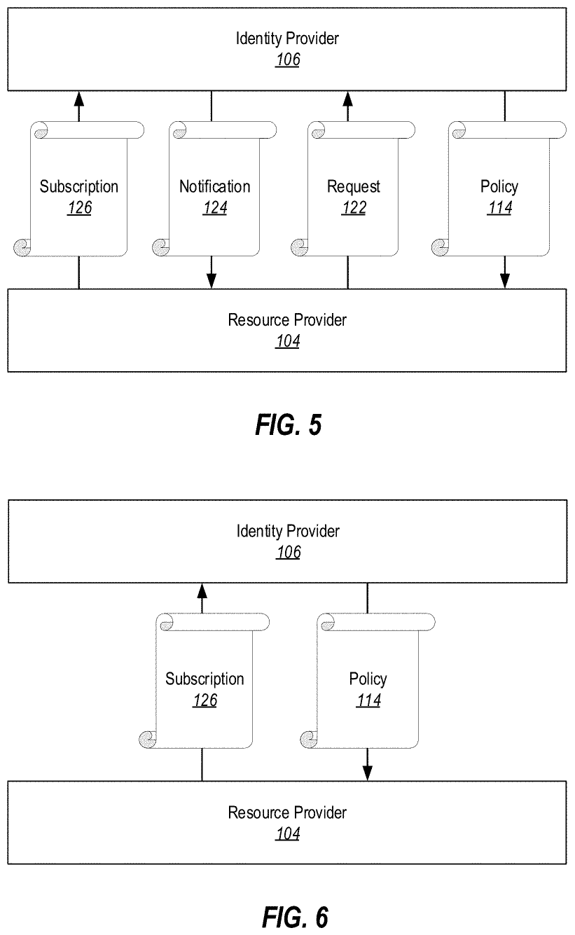

Referring now to FIG. 5, an alternative embodiment is illustrated. In FIG. 5, a resource provider 104 may subscribe to a subscription service at the identity provider 106 or associated with the identity provider 106. In particular, FIG. 5 illustrates a subscription 126 sent from the resource provider 104 to the identity provider 106. The subscription 126 may be applicable to any one of a number of different items. For example, in some embodiments, the resource provider 102 will subscribe to notifications, policy, or combinations thereof for one or more particular entities identified particularly. Alternatively, or additionally, the resource provider 104 may subscribe to certain classes of entities. Alternatively, or additionally, the resource provider 104 may subscribe to policy changes in general from the identity provider 106. This subscription indicates to the identity provider 106 that the resource provider 104 is to be notified when the policy is updated at the identity provider 106. In the example illustrated in FIG. 5, as a result of the subscription 126, a notification 124 (and other notifications over time) is sent to the resource provider 104. The notification 124 indicates to the resource provider 104 that policy is available at the identity provider 106 for the resource provider 104. In response to the notification 124, the resource provider 104 will send a request 122 to the identity provider 106. In response to the request 122, policy 114 is sent from the identity provider 106 to the resource provider 104, where the resource provider 104 can administer the policy locally when entities attempt to access resources from the resource provider 104.

Referring now to FIG. 6, an alternative or additional embodiment is illustrated. In FIG. 6, the resource provider 104 sends a subscription 126 to the identity provider 106. The identity provider 106 can publish events in the form of the policy 114 when additional policy is available to be sent to the resource provider 104. This can help to reduce network overhead traffic to remove the requirement that specific requests for policy be sent from the resource provider 104 to the identity provider 106.

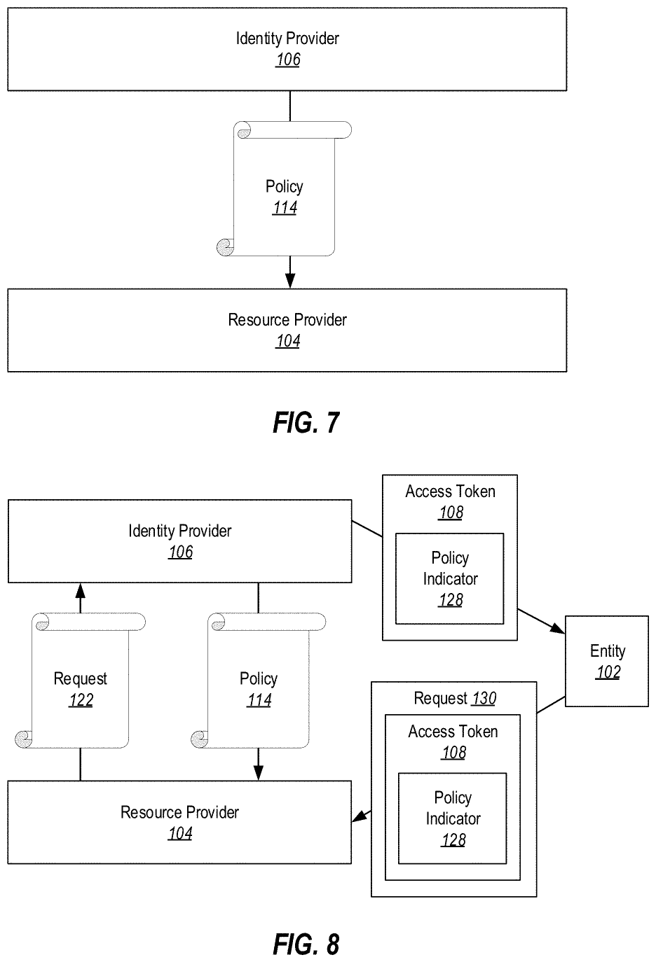

In yet and even simpler example illustrated in FIG. 7, the identity provider 106 may automatically publish the policy 114 to any applicable resource providers such as the resource provider 104.

Referring now to FIG. 8, an alternative or additional embodiment is illustrated. In this example, the entity 102 authenticates with the identity provider 106 to obtain the access token 108. In this particular example, the access token 108 includes a policy indicator 128. The policy indicator 128 includes an indication indicating that policy is available for the entity 102 at the identity provider 106. When the entity 102 requests resources from the resource provider 104 in a request 130, the request 130 will include the access token 108 which includes the policy indicator 128 indicating that policy is available at the identity provider 106 for the entity 102. When the resource provider 104 receives the access token 108 and policy indicator 128, the resource provider 104 can send a request 122 to the identity provider 106. In response to the request 122, the identity provider 106 can provide the policy 114 to the resource provider 104. The resource provider 104 can then administer the policy with respect to the entity 102 as the entity 102 attempts to access the resources 112 provided by the resource provider 104.

The following now illustrates additional details with respect to the types of policy that can be provided to resource providers and administered by the resource providers. As noted previously, embodiments may include location based policy such as policy that identifies the location of an entity 102 attempting to access resources 112 from a resource provider 104. In particular, the policy illustrated above is directed to whether or not the entity 102 is attempting the access from within a corporate intra net or from outside of the corporate intranet. Other location policies may be implemented alternatively, or additionally.

While the example illustrated above is related to policy directed to location, other embodiments may be implemented with other types of policies. For example, in some embodiments, policy may be based on behavioral patterns of users. For example, such behavioral patterns may include typing speed, a usual pattern of typos, intervals between various user inputs, machine usage patterns, application usage patterns, etc. An administrator 120 can configure a policy at the identity provider 106 that indicates that when risk level is increasing due to unexpected user behavioral patterns, that additional authentication is required to access resources. This policy can be provided to the resource provider from the identity provider 106 as illustrated above such that the resource provider 104 can enforce this policy when anomalies are detected in user behavioral patterns. In particular, user behavioral patterns are not easily detected by the identity provider 106 because the identity provider 106 has very limited interaction with the entity 102. That is, the entity 102 performs a limited interaction with the identity provider 106 to obtain an access token 110, and then uses the access token 110 at the resource provider 104 for accessing the resources 112 where a more rich interaction sequence is performed. In this way, the resource provider 104 is more suited to enforce behavioral pattern policy.

However, using the modalities illustrated previously, the policy 114 can nonetheless be configured at the identity provider 106 and subsequently be provided to the resource provider 104 for enforcement directly at the resource provider 104. For example, consider an example where an entity 102 interacts heavily with the resource provider 104. For example, this may occur when an entity uses web-based applications. For example, if an entity is using a web-based email application, web-based word processor, web-based spreadsheet, or even a web-based office suite, user behavioral patterns are readily apparent to the resource provider 104 providing the web-based resources. In particular, the resource provider 104 can readily detect typing speed, typos, switches between applications, or other behavioral patterns. These patterns can be compared with previous patterns exhibited by the entity 102 to detect a significant deviation from previous patterns. When this significant deviation occurs, the resource provider 104 can consult policy 114 provided previously by the identity provider 106 to determine what action should be taken. For example, if the entity 102 has previously authenticated using only single factor authentication, as indicated in an access token 108 provided by the user, and the policy 114 indicates that when a threshold level of variation from user behavioral patterns from previous interactions has occurred, that the session should be terminated, that multi-factor authentication is required, or both. Note that previous interactions may be measured as aggregated and averaged patterns over all time, aggregated and averaged patterns over particular times, a sliding window of patterns, manually configured patterns, combinations thereof, etc. The resource provider 104 can terminate the session and direct the entity 102 back to the identity provider 106 to obtain multi-factor authentication to start a new session with the resource provider 104. Alternatively, the resource provider 104 may be able to determine that the entity 102 already authenticated using multifactor authentication and can continue the session as the current session, in spite of significant changes to behavioral patterns, complies with policy provided by the identity provider 106 to the resource provider 104.

In some embodiments, such as that illustrated in FIG. 8, an access token 108 provided by the identity provider 106 to the entity 102 can include information indicating whether or not policy 114 was configured for the particular entity 102. In particular, not every entity will have a particular type of policy, such as a location policy or behavioral pattern policy or other policy associated with the entity. Thus, some embodiments may include functionality for issuing access tokens with extended information indicating whether or not the policy is configured for the particular entity bearing the token. Thus, for example, if an entity 102 has policy configured for the entity 102 at the identity provider 106, the access token 108 for that entity 102 will indicate that policy exists at the identity provider 106 for the entity 102. Thus, in some examples, when an access token 108 is provided to a resource provider 104 to attempt to obtain access to certain resources 112, the resource provider 104 can inspect the access token 108 and determine that policy exists at the identity provider 106 for the entity 102 presenting the access token 108. In this case, the resource provider 104 can request the policy 114 from the identity provider 106, and can then enforce the policy 114 at the resource provider 104 for the entity 102 providing the access token 108.

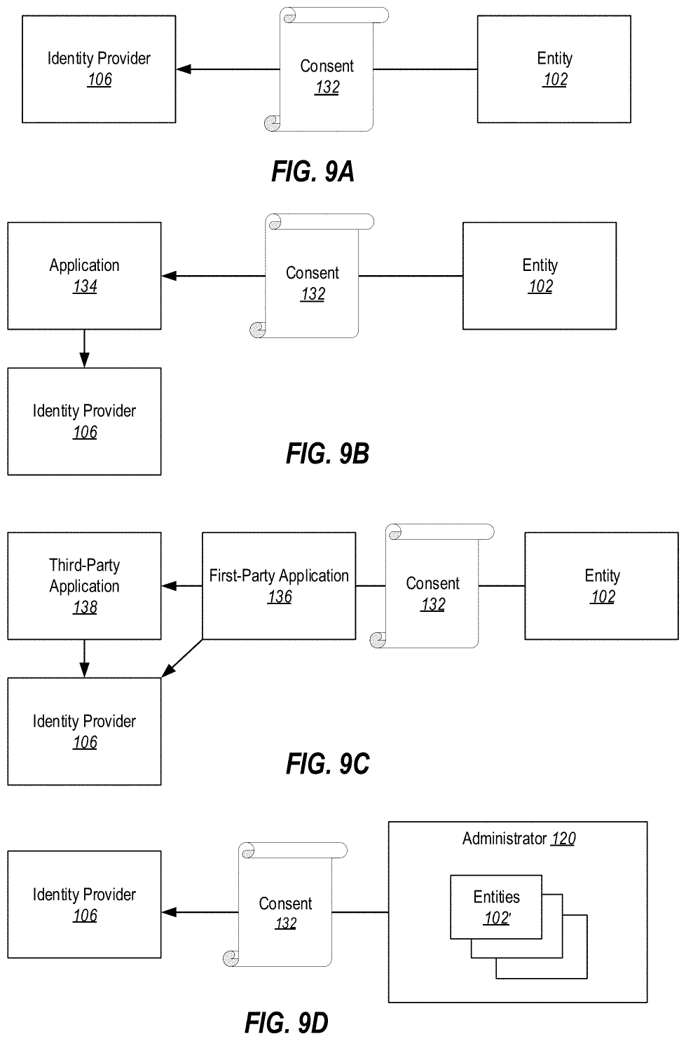

Some embodiments may be implemented where entities provide consent for associated policy related to the entities being issued to resource providers. As illustrated in FIG. 9A, in some embodiments consent may be provided directly by the entity 102 providing consent 132 directly to the identity provider 106. For example, the entity 118 could send a message to the identity provider 106 indicating which service providers have consent to subscribe to the identity provider 106 with respect to the entity 102.

Alternatively or additionally, As illustrated in FIG. 9B, the entity may provide consent 132 to an application 134, and the application 134 may notify the identity provider 106 that the consent is provided. For example, in some embodiments, the application 134 may include a user interface that allows a user to provide the consent as part of the configuration of the application 134.

Alternatively or additionally, as illustrated in FIG. 9C, the consent 132 may be provided by the entity 102 consenting to a first-party application 136 for a different third-party application 138. For example, a user may use their Contoso (a fictional company used for illustration herein) credentials, in a single sign-on scenario, which can be used to authenticate to a third-party application not directly controlled by Contoso. The entity will consent to a first-party Contoso application for the third-party application, thus allowing subscriptions for the entity for the third-party application. For example, FIG. 9C illustrates that the consent 132 can be provided to the first-party application 136. The first-party application 136 can notify the third-party application 138 of the consent (which can then notify the identity provider 106 of the consent 132) or can notify the identity provider 106 directly of the consent 132.

In some embodiments, as illustrated in FIG. 9D, consent may be provided by an administrator 120 for a group of entities including the entity. In the example illustrated in FIG. 9D, the administrator 120 provides consent 132′ to the identity provider 106 on behalf of a set 102′ of entities over which the administrator 120 has control. While the example illustrated in FIG. 9D shows consent provided directly to the identity provider 106, it should be appreciated that in other embodiments, the consent may be provided to applications such as is illustrated in FIGS. 9B and 9C, or other entities.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

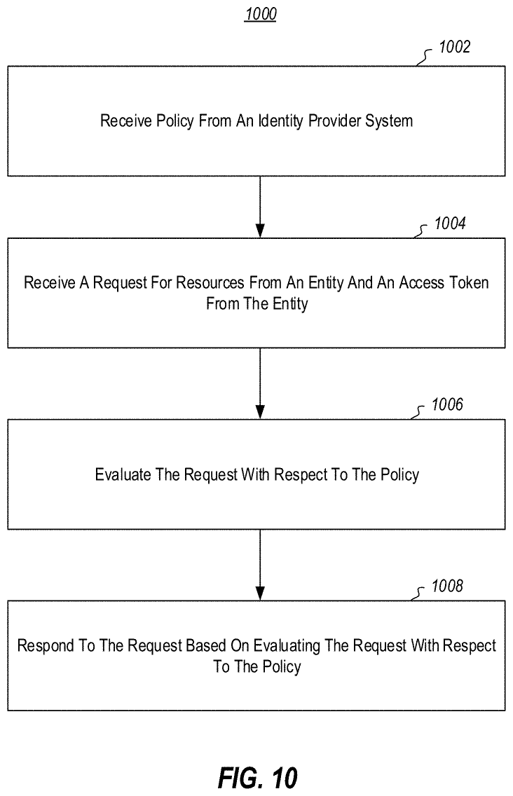

Referring now to FIG. 10, a method 1000 is illustrated. The method 1000 includes acts for implementing policy at a resource provider computer system (act 1002). The method 1000 includes a resource provider computer system receiving policy from an identity provider system, the policy being related to an entity that authenticates using the identity provider computer system.

The method 1000 further includes the resource provider computer system receiving a request for resources from the entity and an access token from the entity (act 1004). The access token was been obtained by the entity from the identity provider computer system as a result of the entity authenticating with the identity provider computer system.

The method 1000 further includes the resource provider computer system evaluating the request with respect to the policy (act 1006).

The method 1000 further includes the resource provider computer system responding to the request based on evaluating the request with respect to the policy (act 1008).

The method 1000 may be practiced where the policy comprises location based restrictions. In some embodiments, the location based restrictions specify that the resource provider computer system should allow access to a particular set of resources when the entity attempts to access the particular set of resources from an intranet but prevents access when the entity attempts to access the particular set of resources from a network external to the intranet. Alternatively or additionally, the location based restrictions specify that the resource provider computer system should allow access to a particular set of resources when the entity attempts to access the particular set of resources from an intranet with an access token obtained using with a first level of authentication but requires a token obtained using an access token obtained with a different second level of authentication to allow access to the particular set of resources when the entity attempts to access the particular set of resources from a network external to the intranet. For example, single factor authentication may be used for requests from an intranet, while multi-factor authentication is required for requests outside of the intranet.

The method 1000 may be practiced where the policy comprises requirements with respect to behavioral pattern policy indicating requirements to be enforced when an entity attempting to access resources at the resource provider computer system exhibits behavioral patterns that exceed a threshold variation from previous behavioral patterns. For example, in some embodiments, the policy requires a token obtained from the identity provider using a different level of authentication to access resources when the behavioral patterns exceed the threshold variation from previous behavioral patterns than when the behavioral patterns do not exceed the threshold variation from previous behavioral patterns.

The method 1000 may be practiced where receiving policy from an identity provider system is performed as a result of the resource provider computer system subscribing to the identity provider computer system for events.

The method 1000 may further include receiving an access token from the entity, the access token having been obtained from the identity provider computer system. The access token includes an indicator indicating that the identity provider computer system has policy to be implemented by the resource provider computer system for the entity. As a result of the indicator in the access token, the resource provider computer system requests the policy. In this example, receiving the policy is performed as a result of the resource provider computer system requesting the policy.

The method 1000 may be practiced where the resource provider computer system receiving policy from an identity provider system is performed based on consent being provided for the entity for the resource provider to receive the policy. In some embodiments, consent is provided by an administrator for a group of entities including the entity. Alternatively or additionally, consent is provided by the entity consenting to a first-party application for a third-party application.

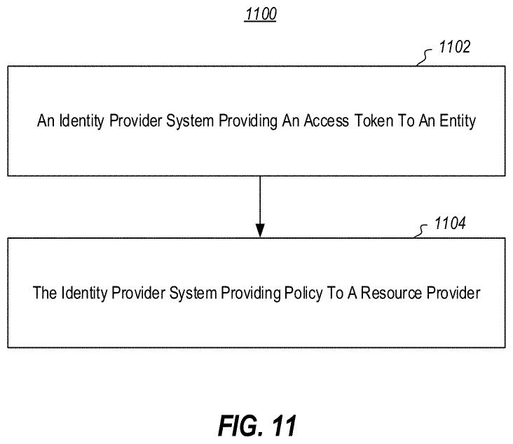

Referring now to FIG. 11, a method of implementing policy in a system is illustrated. The method 1100 includes an identity provider system providing an access token to an entity (act 1102).

The method 1100 further includes the identity provider system providing policy to a resource provider (act 1104). The policy is related to the entity that authenticates using the identity provider computer system to receive the access token. This is done to allow the resource provider computer system, which receives a request for resources from the entity and the access token from the entity, to evaluate the request with respect to the policy and to respond to the request based on evaluating the request with respect to the policy.

The method 1100 may be practiced where the policy comprises location based restrictions. For example, in some embodiments, the location based restrictions specify that the resource provider computer system should allow access to a particular set of resources when the entity attempts to access the particular set of resources from a intranet but prevents access when the entity attempts to access the particular set of resources from a network external to the intranet. Alternatively, or additionally, the location based restrictions specify that the resource provider computer system should allow access to a particular set of resources when the entity attempts to access the particular set of resources from an intranet with an access token obtained using with a first level of authentication, but requires a token obtained using an access token obtained with a different second level of authentication to allow access to the particular set of resources when the entity attempts to access the particular set of resources from a network external to the intra net.

The method 1100 may be practiced where the policy comprises requirements with respect to behavioral pattern policy indicating requirements to be enforced when an entity attempting to access resources at the resource provider computer system exhibits behavioral patterns that exceed a threshold variation from previous behavioral patterns. For example, in some embodiments, the policy requires a token obtained from the identity provider using a different level of authentication to access resources when the behavioral patterns exceed the threshold variation from previous behavioral patterns than when the behavioral patterns do not exceed the threshold variation from previous behavioral patterns.

The method 1100 may further include receiving a subscription request from the resource provider, and be practiced where providing policy to the resource provider system is performed as a result.

The method 1100 may be practiced where the access token comprises an indicator indicating that the identity provider computer system has policy to be implemented by the resource provider computer system for the entity. The method may be practiced where the identity provider receives a request from the resource provider computer system requesting the policy as a result, and sends the policy as a result of receiving a request from the resource provider computer system for the policy.

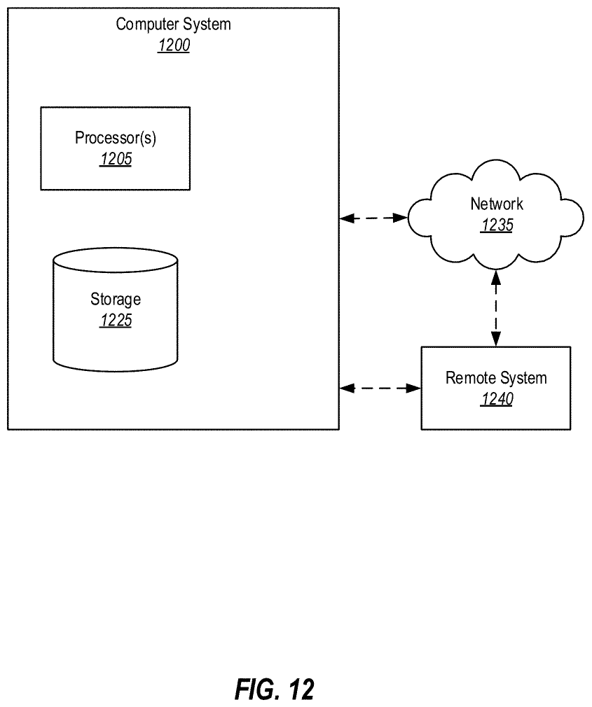

Having just described the various features and functionalities of some of the disclosed embodiments, attention is now directed to FIG. 12, which illustrates an example computer system 1200 that may be used to facilitate the operations described herein. Computer systems, such as system 1200 may be used to implement any of the computer systems described above.

The methods may be practiced by a computer system 1200 including one or more processors 1205 and computer-readable storage 1225 such as computer memory. In particular, the computer memory may store computer-executable instructions that when executed by one or more processors 1205 cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media, such as the storage 1225, for carrying or storing computer-executable instructions, data structures, or combinations thereof. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” (e.g., network 1235) is defined as one or more data links that enable the transport of electronic data between computer systems, modules, other electronic devices, or combinations thereof. When information is transferred or provided over a network or another communications connection (either hardwired, wireless, or a combination of hardwired or wireless) to a computer (e.g., remote system 1240), the computer properly views the connection as a transmission medium. Transmissions media can include a network, or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM, to less volatile computer-readable physical storage media at a computer system, or combinations thereof. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features, methodological acts, or combinations thereof, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of implementing policy at a resource provider computer system, the method comprising:
a resource provider computer system receiving policy from an identity provider system, the policy being related to an entity that authenticates using the identity provider computer system;
the resource provider computer system receiving a request for resources from the entity and an access token from the entity, the access token having been obtained by the entity from the identity provider computer system as a result of the entity authenticating with the identity provider computer system;
the resource provider computer system evaluating the request with respect to the policy; and
the resource provider computer system responding to the request based on evaluating the request with respect to the policy.

2. The method of claim 1, wherein the policy comprises location based restrictions.

3. The method of claim 2, wherein the location based restrictions specify that the resource provider computer system should allow access to a particular set of resources when the entity attempts to access the particular set of resources from an intranet but prevents access when the entity attempts to access the particular set of resources from a network external to the intranet.

4. The method of claim 2, wherein the location based restrictions specify that the resource provider computer system should allow access to a particular set of resources when the entity attempts to access the particular set of resources from an intranet with an access token obtained using with a first level of authentication but requires a token obtained using an access token obtained with a different second level of authentication to allow access to the particular set of resources when the entity attempts to access the particular set of resources from a network external to the intranet.

5. The method of claim 1, wherein the policy comprises requirements with respect to behavioral pattern policy indicating requirements to be enforced when an entity attempting to access resources at the resource provider computer system exhibits behavioral patterns that exceed a threshold variation from previous behavioral patterns.

6. The method of claim 5, wherein the policy requires a token obtained from the identity provider using a different level of authentication to access resources when the behavioral patterns exceed the threshold variation from previous behavioral patterns than when the behavioral patterns do not exceed the threshold variation from previous behavioral patterns.

7. The method of claim 1, wherein receiving policy from an identity provider system is performed as a result of the resource provider computer system subscribing to the identity provider computer system for events.

8. The method of claim 1, further comprising:
receiving an access token from the entity, the access token having been obtained from the identity provider computer system, and wherein the access token comprises an indicator indicating that the identity provider computer system has policy to be implemented by the resource provider computer system for the entity;
as a result of the indicator in the access token, the resource provider computer system requesting the policy; and
wherein receiving the policy is performed as a result of the resource provider computer system requesting the policy.

9. The method of claim 1, wherein the resource provider computer system receiving policy from an identity provider system is performed based on consent being provided for the entity for the resource provider to receive the policy.

10. The method of claim 9, wherein consent is provided by an administrator for a group of entities including the entity.

11. The method of claim 9, wherein consent is provided by the entity consenting to a first-party application for a third-party application.

12. A method of implementing policy in a system, the method comprising:
an identity provider system providing an access token to an entity; and
the identity provider system providing policy to a resource provider, the policy being related to the entity that authenticates using the identity provider computer system to receive the access token, to allow the resource provider computer system, which receives a request for resources from the entity and the access token from the entity, to evaluate the request with respect to the policy and to respond to the request based on evaluating the request with respect to the policy.

13. The method of claim 12, wherein the policy comprises location based restrictions.

14. The method of claim 13, wherein the location based restrictions specify that the resource provider computer system should allow access to a particular set of resources when the entity attempts to access the particular set of resources from a intranet but prevents access when the entity attempts to access the particular set of resources from a network external to the intranet.

15. The method of claim 13, wherein the location based restrictions specify that the resource provider computer system should allow access to a particular set of resources when the entity attempts to access the particular set of resources from an intranet with an access token obtained using with a first level of authentication but requires a token obtained using an access token obtained with a different second level of authentication to allow access to the particular set of resources when the entity attempts to access the particular set of resources from a network external to the intranet.

16. The method of claim 12, wherein the policy comprises requirements with respect to behavioral pattern policy indicating requirements to be enforced when an entity attempting to access resources at the resource provider computer system exhibits behavioral patterns that exceed a threshold variation from previous behavioral patterns.

17. The method of claim 16, wherein the policy requires a token obtained from the identity provider using a different level of authentication to access resources when the behavioral patterns exceed the threshold variation from previous behavioral patterns than when the behavioral patterns do not exceed the threshold variation from previous behavioral patterns.

18. The method of claim 12, further comprising receiving a subscription request from the resource provider, and wherein providing policy to the resource provider system is performed as a result.

19. The method of claim 12, wherein providing an access token to the entity, comprises providing an access token including an indicator indicating that the identity provider computer system has policy to be implemented by the resource provider computer system for the entity, wherein the method further comprises:
as a result of the indicator in the access token, receiving from the resource provider computer system a request for the policy; and
wherein providing the policy is performed as a result of receiving from the resource provider computer system a request for the policy.

20. A computer system comprising:
an identity provider, the identity provider computer system configured to authenticate an entity and to provide an access token to the entity; and
a resource provider computer system configured to:
receive policy from the identity provider system, the policy being related to the entity that authenticates using the identity provider computer system;
receive requests for resources and the access token from the entity;
evaluate the requests with respect to the policy; and
respond to the requests based on evaluating the requests with respect to the policy.
